(19) United States
(12) Patent Application Publication
(10) Pub. No.: US 2006/0078645 A1
(43) Pub. Date: Apr. 13, 2006

(54) Retrofit module for adding a plasticizing and injection unit to an injection molding machine, and injection molding machine with added retrofit module

(75) Inventors: Jorg Seidel, Burgthann (DE); Willi Grotsch, Weigendorf (DE); Ralf Brada, Kolleda (DE); Klaus Rahnhofer, Buchenbach (DE)

Correspondence Address: Henry M. Feiereisen;Henry M. Feiereisen, LLC, Suite 4714, 350 Fifth Avenue, New York, NY, 10118, US

(73) Assignee: Demag Ergotech GmbH, Schwaig (DE)

(21) Appl. No.: 11/247,580

(22) Filed: Oct. 11, 2005

(30) Foreign Application Priority Data
Oct. 8, 2004 (DE) 10 2004 049 361.8

(51) Int. Cl. B29C 45/20

(52) U.S. Cl. 425/568

(57) ABSTRACT

A retrofit module for attachment to an injection molding machine having a plasticizing and injection unit includes a module plasticizing and injection unit, and a support assembly to secure the module plasticizing and injection unit on the injection molding machine independently from the plasticizing and injection unit of the injection molding machine. The module plasticizing and injection unit and the plasticizing and injection unit of the injection molding machine define hereby length axes which extend at an angle of less than 90°. Extending through a nozzle orifice of a platen of the injection molding machine is a nozzle assembly for conducting melt produced by the plasticizing and injection unit of the injection molding machine and the module plasticizing and injection unit. The nozzle assembly is constructed to allow docking of the module plasticizing and injection unit and plasticizing and injection unit of the injection molding machine.

### CROSS-REFERENCES TO RELATED APPLICATIONS

This application claims the priority of German Patent Application, Serial No. 10 2004 049 361.8, filed Oct. 8, 2004, pursuant to 35 U.S.C. 119(a)-(d), the subject matter of which is incorporated herein by reference.

### BACKGROUND OF THE INVENTION

The present invention relates, in general, to an injection molding machine, and more particularly to a retrofit module for adding a plasticizing and injection unit to an injection molding machine.

Nothing in the following discussion of the state of the art is to be construed as an admission of prior art.

Heretofore, standard single-component injection molding machines have been retrofitted to include an additional plasticizing and injection unit by using so-called L and V versions. Hereby, the L version relates to an add-on device which is attached in the horizontal in perpendicular relationship to a major axis of the injection molding machine. Conventionally, an additional machine table with attached plasticizing and injection unit is mounted at right angle to the existing injection molding machine. A retrofitting in accordance with the L configuration is described, for example, in German utility model no. DE 200 10 545 U1, in which a frame is mounted in the area of the mold to the tie bars of an injection molding machine. Pressure fluid cylinders are clamped to vertical frame parts for applying the pressure by which the nozzle is urged into contact between the plasticizing and injection unit and the mold.

The V version involves a positioning of an add-on device vertically above the injection molding machine at right angle to a major axis of the injection molding machine. A base plate is hereby mounted to a platen of the injection molding machine for movably supporting a frame. The frame carries a cross member which supports a second injection unit for movement in substantially perpendicular relationship to the movement direction of the frame. An arrangement of this type is disclosed, for example, in U.S. Pat. No. 6,352,427. The second component is hereby predominantly injected directly into a mold of the injection molding machine, optionally directly in the separation plane of the mold.

Arrangements of the afore-described type require much space. The L configuration requires added space next to the existing injection molding machine so that a smaller number of injection molding machines can be placed in an available room. A problem of the V configuration is the need for a relatively high ceiling of the room in order to provide sufficient clearance for movement of the injection unit away from the injection mold, when the additional injection unit is attached above the injection molding machine, so as to be able to remove injection-molded articles. Oftentimes, the room lacks, however, sufficient ceiling height so that a retrofit according to the V configuration is possible only for very small add-on units or not possible at all.

Multicomponent injection molding machines are known to include additional plasticizing and injection units according to the piggyback or R configuration. This type of configuration involves the placement of the additional plasticizing and injection unit on the same side of a platen, typically the fixed platen, as the primary injection unit which is aligned substantially along a major axis of the injection molding machine. These add-on units are typically mounted at an angle above the primary injection unit and constructed especially for attachment to the bottom unit. These added plasticizing and injection units are not suitable for retrofitting as a consequence of their securement to the lower plasticizing and injection unit and the need to configure the platen for passage of a further plastic component. Thus, a second nozzle orifice must be provided for allowing docking of a nozzle of the second injection unit to the mold, or the nozzle orifice must at least be sized large enough. The use of a second plasticizing and injection unit according to the R configuration thus requires modifications to suit the addition of such a plasticizing and injection unit, for example by providing an additional nozzle orifice in the platen. Retrofitting becomes thus extremely difficult, requiring a replacement of the platen for example.

It would therefore be desirable and advantageous to provide an improved injection molding machine and an improved retrofit module for adding a plasticizing and injection unit to a standard injection molding machine, to obviate prior art shortcomings and to allow installation without substantial modifications of the existing injection molding machine.

### SUMMARY OF THE INVENTION

According to one aspect of the present invention, an injection molding machine includes a platen having a nozzle orifice, first and second plasticizing and injection units which are constructed for attachment on one side of the platen, a support assembly to secure the second plasticizing and injection unit independently from the first plasticizing and injection unit at an angle of less than 90° in relation to the first plasticizing and injection unit, and a nozzle assembly extending through the nozzle orifice of the platen for conducting melt produced by the first and second plasticizing and injection units, with the nozzle assembly being constructed to allow docking of the first and second plasticizing and injection units.

By constructing the injection molding machine in accordance with the present invention, the need for an additional nozzle orifice in the platen is eliminated so that no modifications of the platen are required. The construction of the nozzle assembly to allow docking of both plasticizing and injection units enables their operation independently from one another. The required installation space becomes smaller as both injection units are placed on one side of the platen, suitably the fixed platen, of the injection molding machine and are able to communicate via a common nozzle assembly with an injection mold of the injection molding machine. As the plasticizing and injection units are preferably positioned on the mold-distal side of the platen, the mold is easily accessible. Robots can thus be utilized for depositing inserts or for removing finished injection-molded products. An injection molding machine according to the present invention is very compact and requires less space than before. In particular, an excessive vertical extension can be avoided. Also the need for an additional machine bed, typically used when add-on units of the L version is involved which require must space to the side, is eliminated, and is applicable for use in two-component injection molding. Suitably, the plasticizing and injection units operate according to the so-called screw-piston principle, i.e. the screw of each plasticizing and injection unit assumes plasticizing as well as injection functions.

According to another feature of the present invention, the second plasticizing and injection unit may be secured by the support assembly at an angle of less than 45° in relation to the first plasticizing and injection unit. Thus, the vertical extension as well as the lateral extension is small, permitting easy retrofitting while requiring little space.

According to another feature of the present invention, the nozzle assembly may be constructed in the form of a separating head for producing a skin component and a core component in the mold. The skin component is hereby a material of higher quality than the material for the core component, e.g. recycled material. Separating heads of this type come in various constructions. Melt from both plasticizing and injection units can hereby be routed through a single exit opening to a mold. One or both melt feeds from both plasticizing and injection units to the exit opening or the exit opening itself may be sealable, for example by using a needle shut-off mechanism.

As afore-stated, the nozzle assembly (or separating head) is constructed to allow separate docking of both plasticizing and injection units. This may be implemented for example by simple securement of a forward opening of the plasticizing and injection unit or by applying pressure upon the respective docking station of the nozzle assembly which docket station may be shaped in the form of a calotte. A flow communication between the plasticizing and injection units and a melt feed is hereby is ensured in the nozzle assembly. The use of a nozzle assembly in the form of a separating head thus allows conversion of a standard single component injection molding machine to a two-component injection molding machine in a simple and quick manner so as to allow production of injection-molded articles with skin and core components, also called sandwich structure.

According to another feature of the present invention, the nozzle assembly may be constructed in the form of a twin nozzle which provides a separate flow connection between the plasticizing and injection units and the mold of the injection molding machine. The twin nozzle may include two leading nozzle heads which extend through a single nozzle orifice and can be docked directly to a melt channel of a mold. The use of such a twin nozzle with two melt channels that can be closed separately from one another permits supply of different melt components via a single nozzle orifice of the platen into the mold cavities, whereby both cavities may be temporarily separated by controllable shut-off valves, or supply of a single cavity with two different separate plastic components. The twin nozzle can be configured in many ways. Conceivable is also a single nozzle head with two melt channel openings which can approach a respective docking site of the mold and be linked with associated melt channels for further conduction. Of course, centering or aligning means may be used, as known per se. It is also conceivable to provide two separate nozzle heads of a size small enough to jointly fit through the single nozzle orifice of the platen, while each nozzle head docks to a separate melt channel provided in the mold.

The nozzle assembly may be constructed to allow simple docking of both plasticizing and injection units. Examples include a floating support of the nozzle assembly between the plasticizing and injection units and the mold, or securement of the nozzle assembly to the mold while the plasticizing and injection units are constructed for approach and docking. Of course, it is also within the scope of the present invention to mount the nozzle assembly to one of the plasticizing and injection units whereas the other one of the plasticizing and injection units is constructed for docking on the nozzle assembly solely by applying a pressure and the nozzle assembly is able to dock to the mold under pressure applied by the injection units. Also conceivable is a fixed connection between at least one of the plasticizing and injection units, nozzle assembly, and a mold, or a connection of the nozzle assembly with both plasticizing and injection units.

According to another feature of the present invention, the support assembly may include a carrier with integrated linear guide for attachment of the second plasticizing and injection. The carrier may be arranged for example at approximately right angle to a platen, with the second plasticizing and injection unit being movable along the linear guide. The carrier may also be provided in substantial parallel relationship to the second plasticizing and injection unit to thereby establish an effective force balance when the injection unit applies pressure upon the nozzle assembly.

According to another feature of the present invention, the carrier may be constructed for attachment to a platen of the injection molding machine. This may be appropriate, especially when the second plasticizing and injection unit is of small size, whereby the carrier can then be mounted to the platen via existing bores of the platen. The carrier may also be supportable on a machine bed of the injection molding machine, for example, via support struts, or in addition to the support struts also by securing the carrier to a platen so that the weight of the second plasticizing and injection unit can be better absorbed by the carrier and the additional support, without interfering with the operation of the first plasticizing and injection unit.

Although a substantially lateral support of the second plasticizing and injection unit in relation to the first plasticizing and injection unit is conceivable, it is currently preferred that the second plasticizing and injection unit is positioned substantially above the first plasticizing and injection unit. This type of piggyback disposition results in better space utilization as the second plasticizing and injection unit covers substantially a same ground area as the first plasticizing and injection unit.

As a consequence of the piggyback disposition of the plasticizing and injection units, the nozzle assembly can be supported substantially without encountering bending forces, regardless of the actual connection between the nozzle assembly and the first and second plasticizing and injection units because the contact pressure is applied by the plasticizing and injection units substantially parallel and perpendicular to the platen. The need for separate means to resist transverse forces on the nozzle assembly is thus eliminated. The substantial parallel force introduction into the nozzle assembly also has the positive effect of realizing an improved sealing action between the nozzle assembly and the mold. Seizing of the nozzle assembly into the mold as a result of wear, when the nozzle assembly is subjected to the contact pressure, and thus a change in the contact point between the nozzle assembly and the mold is of no consequence and does not require readjustment because the change in locale can be compensated by the contact pressure substantially applied in injection direction. Of course, in the unlikely scenario that the nozzle assembly is subjected to a transverse force, readjustment will be required after a certain time of operation in order to ensure a flow communication between the nozzle assembly and the mold and thus between the respective melt channels.

As a result of the substantial parallel docking of both plasticizing and injection units to the nozzle assembly, the mobility of the nozzle assembly can be realized, without requiring a detachment of the second plasticizing and injection unit from the nozzle assembly. This decreases cycle time.

At operation, the second plasticizing and injection unit is able to move separately from the first plasticizing and injection unit. Thus, separate drives can be provided for each of the plasticizing and injection units. Of course, both plasticizing and injection units may be constructed for joint movement as well, for example by having the first plasticizing and injection unit conjointly move the second plasticizing and injection unit. In this case, only one drive is needed, thereby rendering the injection molding machine according to the invention even more compact and easier to manufacture.

According to another feature of the present invention, the nozzle assembly may be received, at least portions thereof, in a pocket of the platen in an area of the nozzle orifice. In this way, additional space can be saved and in particular the length dimension of the injection molding machine can be further reduced. This manner of construction becomes possible also because of the substantial parallel force introduction by the two plasticizing and injection units into the nozzle assembly.

According to another aspect of the present invention, a retrofit module for attachment to an injection molding machine having a plasticizing and injection unit includes a module plasticizing and injection unit, a support assembly to secure the module plasticizing and injection unit on the injection molding machine independently from the plasticizing and injection unit of the injection molding machine, wherein the module plasticizing and injection unit and the plasticizing and injection unit of the injection molding machine define length axes extending substantially at an angle of less than 90°, and a nozzle assembly extending through a nozzle orifice of a platen of the injection molding machine for conducting melt produced by the plasticizing and injection unit of the injection molding machine and the module plasticizing and injection unit, with the nozzle assembly being constructed to allow docking of the module plasticizing and injection unit and plasticizing and injection unit of the injection molding machine.

According to another feature of the present invention, the module plasticizing and injection unit may be movably secured to a platen of the injection molding machine. In this way, the module plasticizing and injection unit is able to move to and away in relation to the nozzle assembly. This is advantageous during setup but also during change of components and cleaning operations.

According to another feature of the present invention, the length axes of the module plasticizing and injection unit and the plasticizing and injection unit of the injection molding machine may extend at an angle of less than 45°. In this way the installation space of the retrofit module is further reduced.

The nozzle assembly may be floatingly supported between the plasticizing and injection units and a mold, or the plasticizing and injection unit of the injection molding machine and/or the module plasticizing and injection unit may be fixedly connected to the nozzle assembly or through application of a contact pressure to ensure a flow connection.

A retrofit module according to the present invention can be advantageously mounted to an existing injection molding machine, whether a single component injection molding machine or multi-component injection molding machine is involved, for adding a further plasticizing and injection unit, in a simple manner and independently of the existing plasticizing and injection unit of the injection molding machine. The nozzle assembly is so constructed that the module plasticizing and injection unit and the plasticizing and injection unit of the injection molding machine can be positioned on one side of a platen, thereby requiring little installation space while still maintaining easy access and exhibiting relatively small height.

According to another feature of the present invention, the support assembly may include a carrier for attachment of the module plasticizing and injection unit and securement to an injection molding machine, with the carrier having integrated therein a linear guide for allowing movement of the module plasticizing and injection unit. Thus, the module plasticizing and injection unit can be constructed for docking to the nozzle assembly or to the mold and can be transferred by an appropriate drive to a position that is beneficial for retrofitting works. The drive may hereby also be used to apply the contact pressure.

Suitably, the carrier may be mounted to a platen, normally the fixed platen, of the injection molding machine, via fasteners such as bolts, screws or the like that are received in typical bores of the platen. Thus, retrofitting is simple in the absence of any substantial modifications of the injection molding machine.

According to another feature of the present invention, the carrier may be supported on a machine bed of an injection molding machine. In addition, the carrier may also be mounted to a platen to better absorb the weight of the added plasticizing and injection unit of the retrofit module. Thus, the retrofit module can be suited and secured in a particularly simple manner to an existing injection molding machine.

According to another feature of the present invention, the nozzle assembly can be constructed for conducting the melt from the plasticizing and injection unit of the injection molding machine and the module plasticizing and injection unit through a common melt channel or through two separate melt channels guided through the nozzle orifice of a platen of the injection molding machine. The nozzle assembly may also be constructed in such a way as to be able to dock to two different melt channels in a mold or also to a single melt channel. Regardless of the construction, the nozzle assembly ensures a passage of the melt from both plasticizing and injection units through a single nozzle orifice which represents a standard component of a single component injection molding machine. So-called separating heads may hereby be used for sandwich molding, or twin nozzles may be used which provide two different exit openings for the melt from the nozzle assembly.

According to another feature of the present invention, the module plasticizing and injection unit may be positioned substantially above the plasticizing and injection unit of the injection molding machine. This construction is space-saving and results in a compact retrofitted injection molding machine.

A standard injection molding machine which has been retrofitted with a further plasticizing and injection unit as well as a retrofit module with a plasticizing and injection unit for adding to an injection molding machine are very compact and space saving, whereby the retrofit module permits addition of a plasticizing and injection unit to a standard injection molding machine in a simple manner, without modification of the standard injection molding machine. Compared to conventional L and V constructions, the retrofit module according to the present invention results in substantial space saving and is flexible as well as enables rapid change-over times.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic perspective illustration of an injection side of an injection molding machine retrofitted with a retrofit module according to the present invention for adding a plasticizing and injection unit;

FIG. 2 is a sectional view of a first variant of a nozzle assembly of a retrofit module according to the present invention; and

FIG. 3 is a sectional view of a second variant of a nozzle assembly of a retrofit module according to the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

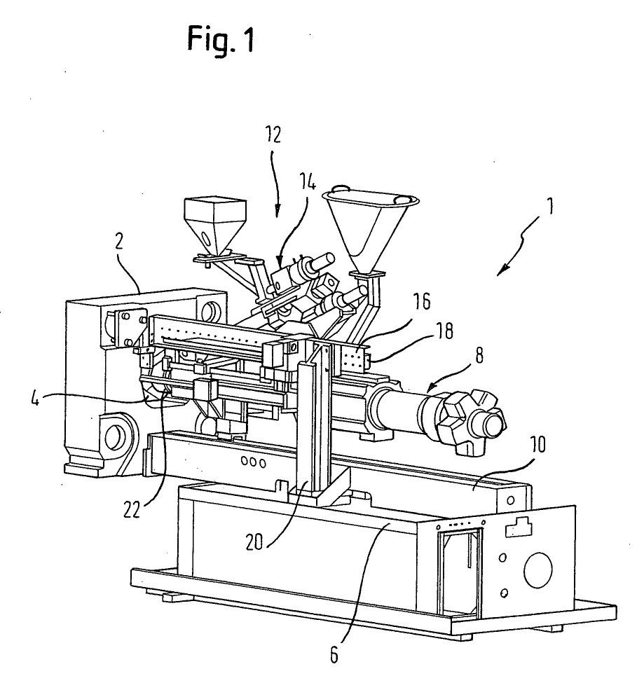

Turning now to the drawing, and in particular to FIG. 1, there is shown a schematic perspective illustration of an injection side of an injection molding machine, generally designated by reference numeral 1 and retrofitted with a retrofit module according to the present invention, generally designated by reference numeral 12 for adding a plasticizing and injection unit 14. The injection molding machine 1 is of standard type, when initially delivered in the absence of the retrofit module 12, and includes a machine bed 6 and a platen 2, here the fixed platen. A plasticizing and injection unit 8 of the injection molding machine 1, which is supported on the machine bed 6 via a linear guide 10, is movably mounted to the linear guide 10 for travel in relation to the platen 2. The platen 2 is formed with a standard nozzle orifice 4 via which the plasticizing and injection unit 8 conducts plasticized material via a nozzle to an unillustrated injection mold of the injection molding machine.

As shown in FIG. 1, the retrofit module 12 is attached to this standard injection molding machine 1 to add the plasticizing and injection unit 14. The retrofit module 12 includes a support assembly for attachment of the plasticizing and injection unit 14. The support assembly includes a carrier 16 which is mounted to the platen 2 and supported on the machine bed 6 via a support beam 20. The carrier 16 includes an integrated linear guide 18 for attachment of the plasticizing and injection unit 14 and mobility of the plasticizing and injection unit 14 in relation to the platen 2. The retrofit module 12 further includes a nozzle assembly 22 which is received in the nozzle orifice 4 and establishes a connection between the plasticizing and injection unit 8 and the plasticizing and injection unit 14, on one hand, and the injection mold, on the other hand. The nozzle assembly 22 is mounted to the plasticizing and injection unit 8, whereas the plasticizing and injection unit 14 is able to dock onto the nozzle assembly by moving the plasticizing and injection unit 14 to the docking position. The plasticizing and injection units 8, 14 extend relative to one another at an angle of less than 90°, in particular less than 45°, whereby the plasticizing and injection unit 14 is positioned above the plasticizing and injection unit 8.

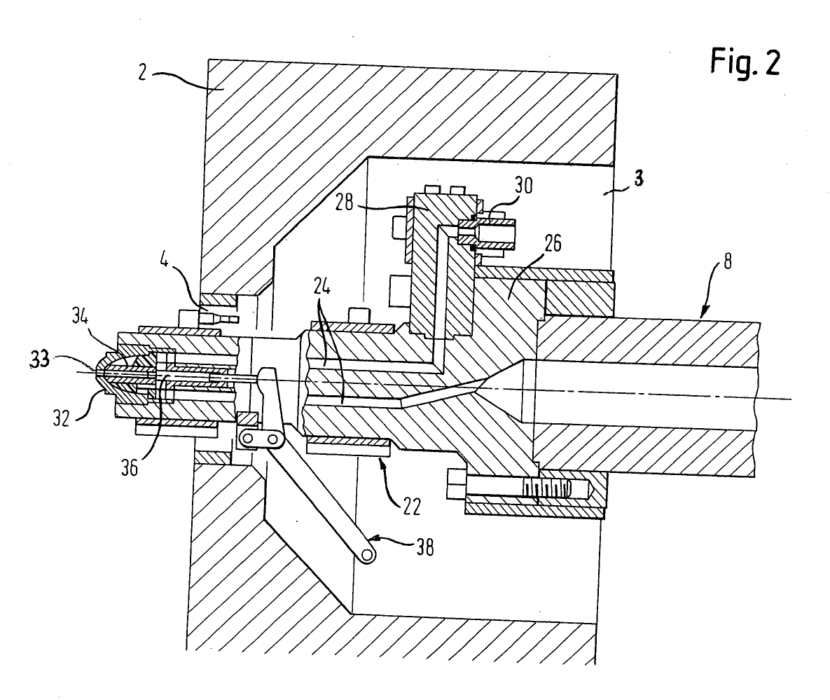

Turning now to FIG. 2, there is shown a sectional view of a first variant of a nozzle assembly 22 of a retrofit module 12 according to the present invention. The nozzle assembly 22 is constructed in the form of a separating head for generating a skin component and a core component in the mold and extends through the nozzle orifice 4. The nozzle assembly 22 has channels 24 for establishing a flow connection between a docking station 26 for the plasticizing and injection unit 8 and a docking station 28 for the plasticizing and injection unit 14, on one hand, and a forward nozzle head 32, on the other hand. The nozzle head 32 has a single exit opening 33 for discharge and injection of melt from the plasticizing and injection units 8, 14 into the injection mold. Injection of the melt from the two plasticizing and injection units 8, 14 may take place parallel or successively. The plasticizing and injection unit 14 (not shown in greater detail in FIG. 2) has a docking nozzle 30 for placement in a calotte of the docking station 28. Snug-fitted docking is hereby realized, when the plasticizing and injection unit 14 is under pressure.

A nozzle insert 34 accommodates a needle 36 of a needle shut-off mechanism 38 and is sealingly received in the nozzle head 32. Structure and operation of such a needle shut-off mechanism 38 is generally known by the artisan so that a detailed discussion thereof is omitted for the sake of simplicity. The forces applied by the plasticizing and injection units 8, 14 act substantially parallel in relation to an injection direction, thereby realizing a good sealing action between the nozzle assembly 22 and the mold, and thereby subjecting the nozzle assembly 22 to negligible bending moments only. The nozzle assembly 22 is received, at least partially, in a pocket 3 of the platen 2 to thereby limit the length dimension of the injection molding machine 1.

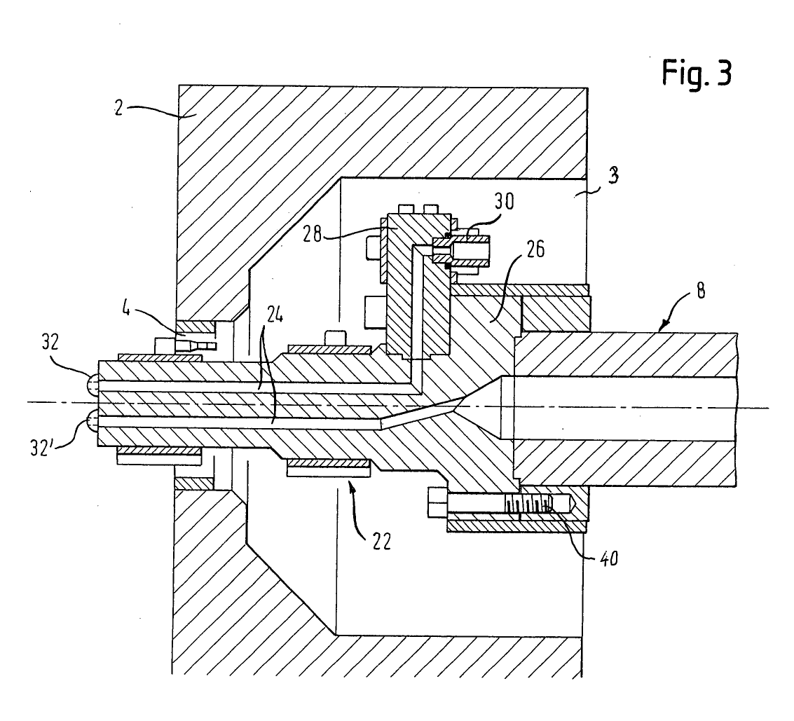

FIG. 3 shows a sectional view of a second variant of a nozzle assembly 22 of a retrofit module 12 according to the present invention. Parts corresponding with those in FIG. 2 are denoted by identical reference numerals and not explained again. The description below will center on the differences between the variants. In this embodiment, the nozzle assembly 22 is constructed to allow docking of the plasticizing and injection unit 8 and securement to the docking station 26 via screw fasteners 40, and to allow docking of the docking nozzle 30 of the otherwise unillustrated plasticizing and injection unit 14 of the retrofit module 12 to the docking station 28. The nozzle assembly 22 is constructed in the form of a twin nozzle with two channels 24 for conducting melt from the plasticizing and injection units 8, 14 via corresponding nozzle heads 32, 32′ to sealingly connect channels in an unillustrated mold which is mounted to the platen 2. The forward portion of the nozzle assembly 22 is hereby sized to extend through the existing nozzle orifice 4 of the platen 2. The melt channels 24 in the nozzle assembly 22 are hereby separated from one another. The nozzle assembly 22 is received, at least partly, also in this embodiment in a pocket 3 of the platen 2 to provide a compact configuration of the retrofitted injection molding machine 1.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An injection molding machine, comprising:
a platen having a nozzle orifice;
a first plasticizing and injection unit;
a second plasticizing and injection unit, wherein the first and second plasticizing and injection units are constructed for attachment on one side of the platen;
a support assembly to secure the second plasticizing and injection unit independently from the first plasticizing and injection unit at an angle of less than 90° in relation to the first plasticizing and injection unit; and
a nozzle assembly extending through the nozzle orifice of the platen for conducting melt produced by the first and second plasticizing and injection units, said nozzle assembly being constructed to allow docking of the first and second plasticizing and injection units.

2. The injection molding machine of claim 1, wherein the second plasticizing and injection unit is secured by the support assembly at an angle of less than 45° in relation to the first plasticizing and injection unit.

3. The injection molding machine of claim 1, wherein the second plasticizing and injection unit is fixedly secured by the support assembly to the platen.

4. The injection molding machine of claim 1, wherein the second plasticizing and injection unit is movably secured by the support assembly to the platen.

5. The injection molding machine of claim 1, further comprising a mold, wherein the nozzle assembly is constructed in the form of a separating head for producing a skin component and a core component in the mold.

6. The injection molding machine of claim 1, further comprising a mold, wherein the nozzle assembly is constructed in the form of a twin nozzle received in the nozzle orifice and having two separate melt channels between the first and second plasticizing and injection units and the mold.

7. The injection molding machine of claim 1, further comprising a mold, wherein the nozzle assembly is constructed for a floating support between the first and second plasticizing and injection units and the mold.

8. The injection molding machine of claim 1, wherein the nozzle assembly is received, at least partly, in a pocket of the platen in an area of the nozzle orifice.

9. The injection molding machine of claim 1, further comprising a mold, wherein the nozzle assembly is constructed for securement to one of the first and second plasticizing and injection units, with the other one of the first and second plasticizing and injection units docking to the nozzle assembly solely by applying a pressure, and with the nozzle assembly docking to the mold under pressure applied by the plasticizing and injection units.

10. The injection molding machine of claim 4, wherein the support assembly includes a carrier for attachment of the second plasticizing and injection unit and a linear guide on the carrier for allowing movement of the second plasticizing and injection unit relative to the platen.

11. The injection molding machine of claim 10, wherein the carrier extends at a right angle to the platen.

12. The injection molding machine of claim 10, wherein the carrier extends in substantial parallel relationship to the second plasticizing and injection unit.

13. The injection molding machine of claim 10, wherein the carrier is constructed for attachment to the platen.

14. The injection molding machine of claim 10, further comprising a machine bed for support of the carrier.

15. The injection molding machine of claim 1, wherein the second plasticizing and injection unit is positioned substantially above the first plasticizing and injection unit.

16. The injection molding machine of claim 1, further comprising a mold, wherein the side of the platen for attachment of the first and second plasticizing and injection units is the mold distal side of the platen.

17. The injection molding machine of claim 1, wherein the platen is the fixed platen of the injection molding machine.

18. A retrofit module for attachment to an injection molding machine having a plasticizing and injection unit, said retrofit module comprising:
a module plasticizing and injection unit;
a support assembly to secure the module plasticizing and injection unit on the injection molding machine independently from the plasticizing and injection unit of the injection molding machine, wherein the module plasticizing and injection unit and the plasticizing and injection unit of the injection molding machine define length axes extending at an angle of less than 90°; and
a nozzle assembly capable of extending through a nozzle orifice of a platen of the injection molding machine for conducting melt produced by the plasticizing and injection unit of the injection molding machine and the module plasticizing and injection unit, said nozzle assembly being constructed to allow docking of the module plasticizing and injection unit and plasticizing and injection unit of the injection molding machine.

19. The retrofit module of claim 18, wherein the length axes extend at an angle of less than 45°.

20. The retrofit module of claim 18, wherein the plasticizing and injection unit of the module is fixedly secured by the support assembly to a platen of the injection molding machine.

21. The retrofit module of claim 18, wherein the plasticizing and injection unit of the module is movably secured by the support assembly to a platen of the injection molding machine.

22. The retrofit module of claim 18, wherein the support assembly includes a carrier for attachment of the module plasticizing and injection unit and a linear guide on the carrier for allowing movement of the module plasticizing and injection unit.

23. The retrofit module of claim 22, wherein the carrier extends at a right angle to the platen.

24. The retrofit module of claim 22, wherein the carrier extends in substantial parallel relationship to the module plasticizing and injection unit.

25. The retrofit module of claim 22, wherein the carrier is constructed for attachment to a platen of the injection molding machine.

26. The retrofit module of claim 22, wherein the carrier is constructed for attachment to a machine bed of the injection molding machine.

27. The retrofit module of claim 18, wherein the nozzle assembly is constructed for conducting melt from the plasticizing and injection unit of the injection molding machine and the module plasticizing and injection unit through a common nozzle head receivable in the nozzle orifice.

28. The retrofit module of claim 18, wherein the nozzle assembly is constructed for conducting melt from the plasticizing and injection unit of the injection molding machine and the module plasticizing and injection unit through two separate nozzle heads in one-to-one correspondence, with the nozzle heads receivable in the nozzle orifice.

29. The retrofit module of claim 18, wherein the module plasticizing and injection unit is positionable substantially above the plasticizing and injection unit of the injection molding machine.

30. A retrofit module for adding a plasticizing and injection unit to a standard injection molding machine, said retrofit module comprising a nozzle assembly constructed for attachment to a mold of the injection molding machine and capable of extending through a nozzle orifice of a platen of the injection molding machine, said nozzle assembly having a first docking station for attachment of a plasticizing and injection unit of the injection molding machine, and a second docking station for attachment of an add-on plasticizing and injection unit at an angle of less than 90° in relation to the plasticizing and injection unit of the injection molding machine, said nozzle assembly having passageway means for conducting melt produced by the plasticizing and injection unit of the injection molding machine and the add-on plasticizing and injection unit through the nozzle orifice.
